(19) United States
(12) Patent Application Publication
(10) Pub. No.: US 2002/0055802 A1
(43) Pub. Date: May 9, 2002

(54) System and method for controlling semiconductor device manufacturing flow

(75) Inventors: To-oru Yasuda, Tokyo (JP); Junji Tateishi, Tokyo (JP)

Correspondence Address: McDermott, Will & Emery, 600 13th Street, N.W., Washington, DC, 20005-3096, US

(73) Assignee: MITSUBISHI DENKI KABUSHIKI KAISHA

(21) Appl. No.: 09/983,652

(22) Filed: Oct. 25, 2001

(30) Foreign Application Priority Data
Nov. 7, 2000 (JP) 2000-339632

(51) Int. Cl. G06F 19/00

(52) U.S. Cl. 700/112; 700/99; 700/117; 700/121; 700/115

(57) ABSTRACT

A system and method for controlling the flow of manufacturing semiconductor devices that can prevent the occurrence of defects in semiconductor devices or the damage of manufacturing equipment due to the lack of the knowledge or the carelessness of the producer of the flow of manufacturing semiconductor devices.

The shift between desired processes can be restricted or corrected by preparing a shift rule to recognize the shift between processes in a manufacturing flow, based on category attribute, and applying this shift rule to a manufacturing flow recording section in which information including the process device ID, shift between processes, and category attribute. The order of desired processes, or the like, can be limited or corrected by preparing an order rule for determining the recognition of the order of processes or the presence of processes in the manufacturing flow using a plurality of parameters that specify the starting process and the like, and by applying this order rule to a manufacturing flow recording section for recording information including the process names, process device IDs, and the like.

### BACKGROUND OF THE INVENTION

1. Field of the Invention

The present invention relates to a system and method for controlling the flow of manufacturing semiconductor devices.

2. Description of Related Art

The order or parameter values of each process contained in the flow of manufacturing semiconductor devices are decided so that the physical shape end electrical properties of the relevant semiconductor device are within a desired range. In general, the above-described manufacturing flow has repeatedly been improved based on past experiences, and is applied to the manufacture of new semiconductor devices. On the other hand, the manufacturing flow to be prohibited has also been known from past experiences. For example, if a metal or an organic substance is mixed in a thermal oxidation furnace for forming a gate oxide film, the gate oxide film is degraded and desired properties cannot be obtained. Therefore, to charge a wafer into the furnace in a process where a metal film or a resist is exposed on its surface should be prohibited.

Heretofore, the above-described prohibited items in the semiconductor manufacturing flow has been removed from the manufacturing flow depending of the knowledge of the producer of each flow. Therefore, problems of the occurrence of defects in semiconductor devices, or the damage of manufacturing equipment have arose due to the lack of the knowledge or the carelessness of the producer of the flow of manufacturing semiconductor devices.

### SUMMARY OF THE INVENTION

Therefore, the object of the present invention is to solve the above-described problems, and to provide a system and method for controlling the flow of manufacturing semiconductor devices that can prevent the occurrence of defects in semiconductor devices or the damage of manufacturing equipment due to the lack of the knowledge or the carelessness of the producer of the flow of manufacturing semiconductor devices.

According to a first aspect of the present invention, there is provided a system for controlling the flow of manufacturing semiconductor devices comprising: a manufacturing flow recording section for recording information for each process of the manufacturing flow, containing the category attribute that indicates the classification according to materials used in the process; and a shift rule section for recording the shift rule by which the recognition of shift between each process of the manufacturing flow is decided based on the category attribute.

According to a second aspect of the present invention, there is provided a system for controlling the flow of manufacturing semiconductor devices comprising: a manufacturing flow recording section for recording information for each process of the manufacturing flow, containing the process identifier that describes the relevant process; and an order rule section for recording the order rule that specifies the order of appearance of each step for specific processes that contains a plurality of steps in the manufacturing flow recording section.

According to a third aspect of the present invention, there is provided a system for controlling the flow of manufacturing semiconductor devices comprising: a manufacturing flow recording section for recording information for each process of the manufacturing flow, containing the step identifier that describes the relevant step and the parameter section wherein the value of the specified parameter used in the relevant step; and a parameter value rule section for recording the parameter value rule that specifies the relationship between parameter values recorded in the parameter section for the relevant process, for the specified processes having a plurality of steps in the manufacturing flow recording section.

According to a fourth aspect of the present invention, there is provided a system for controlling the flow of manufacturing semiconductor devices comprising a manufacturing flow recording section for recording information for each process of the manufacturing flow, containing the step identifier that describes the relevant step and the parameter section wherein the value of the specified parameter used in the relevant step is set; and a simulation rule section for recording the simulation rule that makes the shape simulator identify the material present on the surface of a wafer in the specific step, using the parameter recorded in the parameter section of the step before the specific step in the manufacturing flow recording section.

According to a fifth aspect of the present invention, there is provided a method for controlling the flow of manufacturing semiconductor devices using, for each process of the manufacturing flow, a manufacturing flow recording section for recording information for each process of the manufacturing flow, containing the category attribute that indicates the classification according to materials used in the process, and a shift rule section for recording the shift rule by which the recognition of shift between each process of the manufacturing flow is decided based on the category attribute, the method comprising the steps of a determination step for determining the recognition of shift between each process by applying the shift rule to the category attribute for each process recorded in the manufacturing flow recording section; and correcting the manufacturing flow by warning or by changing the category attribute for the process, when there is a process for which the determination step has denied the shift.

According to a sixth aspect of the present invention, there is provided a method for controlling the flow of manufacturing semiconductor devices using, for each process of the manufacturing flow, a manufacturing flow recording section for recording information containing the process identifier that describe the process, and an order rule section for recording the order rule that specifies the order of appearance of each step, wherein the order rule recorded in the order rule recording section has, the step identifier, a direction identifier for indicating the test direction in the manufacturing flow of the specific processes, a prohibited step identifier for indicating the step whose presence is prohibited in the specific processes, an essential step identifier for indicating the step whose presence is essential in the specific processes, a process completion identifier for indicating the completion of the specific processes, and a test number identifier for indicating the number of steps that require testing, the method comprising the steps of: a determination step for determining the recognition of the order of each step and the recognition of the presence of each step by applying the order rule to the step identifier recorded in the manufacturing flow recording section; and correcting the manufacturing flow by warning or changing the process when there is a process for which the determination step has denied the order or presence thereof.

According to a seventh aspect of the present invention, there is provided a method for controlling the flow of manufacturing semiconductor devices using, for each process of the manufacturing flow, a manufacturing flow recording section for recording information containing for each process of the manufacturing flow, a step identifier that describes the relevant step and the parameter section wherein the value of the specified parameter used in the relevant step is set, and a parameter value rule section for recording the parameter value rule that specifies the relationship between parameter values recorded in the parameter section in the relevant process, for the specified processes having a plurality of steps in the manufacturing flow recording section, wherein the parameter value rule recorded in the parameter value rule recording section has, the step identifier of the specific step, a direction identifier for indicating the test direction in the manufacturing flow of the specific processes, a condition section for indicating the relationship between parameter values, a conditional process identifier subjected to the determination of the relationship indicated by the condition section, a process completion identifier for indicating the completion of the specific processes, and a test number identifier for indicating the number of steps that require testing, the method comprising the steps of: a determination step for determining the existence of the relationship between parameters indicated in the condition section by applying the parameter value rule to the parameter section recorded in the manufacturing flow recording section; and correcting the manufacturing flow by warning or changing the parameter value recorded in the parameter section for the process when there is a process for which the determination step has denied the presence thereof.

According to a eighth aspect of the present invention, there is provided a method for controlling the flow of manufacturing semiconductor devices using, for each process of the manufacturing flow, a manufacturing flow recording section for recording information for each process of the manufacturing flow, containing the step identifier that describes the relevant step and the parameter section wherein the value of the specified parameter used in the relevant step is set, and a simulation rule section for recording the simulation rule that makes the shape simulator identify the material present on the surface of a wafer in the specific step, using the parameter recorded in the parameter section of the step before the specific step in the manufacturing flow recording section, wherein the simulation rule recording section has, a step identifier of the specific step, a parameter used when the shape simulator is activated, an essential material identifier indicating the material whose existence on the surface of the wafer is assumed in the specific step, and a prohibited material identifier for indicating the prohibited material considered to damage the semiconductor device, when present on the surface of a wafer in the specific step, the method comprising the steps of: a determination step for determining the coincidence of the material present on the surface of a wafer made the shape simulator specify using the simulation rule, with the prohibited material indicated by the prohibited material identifier; and correcting the manufacturing flow by warning or changing the parameter value recorded in the parameter section of the step before the specific step, when the determination step has determined coincidence.

The above and other objects, effects, features and advantages of the present invention will become more apparent from the following description of the embodiments thereof taken in conjunction with the accompanying drawings.

### BRIEF DESCRIPTION OF THE DRAWINGS

FIG. 1 shows an example of the process rules (shift rule) in Embodiment 1 of the present invention.

FIG. 2 shows a list of example determinations of the process flow (manufacturing flow recording section) by the shift rule shown in FIG. 1

FIG. 3 shows an example of order rules to specify the order of appearance between processes in Embodiment 2 of the invention established using the above-described parameters

FIG. 4 shows a method for checking the manufacturing flow using the order rules in Embodiment 2 of the present invention using a flow chart.

FIG. 5 shows a list of example determinations of the process flow (manufacturing flow recording section) by the order rules shown in FIG. 3 and the flow chart shown in FIG. 4.

FIG. 6 shows an example of order rules to specify the order of appearance between processes established using the above-described parameters in Embodiment 3 of the invention.

FIG. 7 shows a list of example determinations of the process flow (manufacturing flow recording section) by the parameter value rule shown in FIG. 6 and the flow chart shown in FIG. 4.

FIG. 8 shows the flow of data in checking the process rule in Embodiment 4.

FIG. 9 shows an example of the simulation rule to make the topography simulator specify the material present on the surface of the wafer in Embodiment 4 made by using the above-described parameters.

FIG. 10 shows a list of example determinations of the process flow (manufacturing flow recording section) by the simulation rule shown in FIG. 9 and the flow chart shown in FIG. 4.

FIGS. 11 (A) and (B) show mask patterns used for topography simulation in Embodiment 4.

FIGS. 12 (A) and (B) show the examples of the results of topography simulation using mask patterns 10 and the like as shown in FIGS. 11 (A) and (B).

### DETAILED DESCRIPTION OF THE PREFERRED EMBODIMENTS

First, the present invention will be summarized, and then the embodiments of the present invention will be described in detail referring to drawings.

A semiconductor device manufacturing flow consists of a number of processes, and each process has a plurality of parameters. When the numerals representing the order of the processes are defined as “process numbers”, each process will form a manufacturing flow if it has the “process device ID” and the “process condition ID (recipe ID)” as the minimum parameter. However, even the same device may play different roles in the manufacturing process depending on process conditions, and the list of “process condition ID (recipe ID)” is difficult for the controller to understand which type of role the process plays. It is therefore the common practice to allocate the “process name” to each process so as to reflect the role of each process. The “manufacturing flow” will be described below as the set of data having at least a “process number”, a “process name”, a “process device ID”, and a “process condition ID (recipe ID or manufacturing parameter (group))” as parameters.

The control system of the manufacturing flow is formed of a computer and software executed on the computer. The data to be handled are the manufacturing flow represented by the set of data and the related data as described above, and these are recorded in the database (manufacturing flow recording section). Furthermore, the rules related to the order of processes, the range of parameters, and the like in the manufacturing flow (hereafter called “process rule”) are recorded in the database for rules (shift rule section, order rule section, parameter value rule section, simulation rule section, and the like).

The flow of the operations for controlling the manufacturing flow is summarized as follows:

(Step 1) The databases of the process rules are prepared.

(Step 2) The manufacturing flow is prepared.

(Step 3) The manufacturing flow is tested according to the process rules.

(Step 4) The defect found in the test is corrected.

The above-described (Step 1) is the operation to pattern the process rules based on past experiences and existing knowledge, and to prepare databases for the rules on the computer. (Step 2) is the operation to prepare on the databases the manufacturing flow considered to be necessary for realizing the desired semiconductor device. (Step 3) is the operation to make the computer retrieve whether there is the pattern of the process rule prepared in (Step 1) in the manufacturing flow prepared in (Step 2) or not. (Step 4) is the operation to correct the flow if a flow that has a problem in view of the process rules is found in (Step 3) If the problem is simple. the process rule can be corrected automatically at the same time of the test in (Step 3), by adding a correction algorithm to the databases for the rules in advance. However, if such an algorithm does not correct the flow, an alarm message is given to the operator. The operator corrects the flow, and returns to the rule test.

Embodiment 1

Each process for manufacturing semiconductor devices uses different materials according to the role thereof. At this time, materials used may remain in equipment used in each process (process equipment). However, if Al or Cu used in wiring layers, for example, is mixed in a gate insulation film or a capacitor insulation film, the insulating performance is degraded: therefore, the use of process equipment for forming wiring layers in the gate forming process must be avoided. It is effective to group the pieces of process equipment into categories according to materials to be used and to limit the shift of the processes between the categories. That is, the contamination of equipment and products can be avoided by allocating a category attribute that indicates the process cleanliness to each process, and by setting desired process rules.

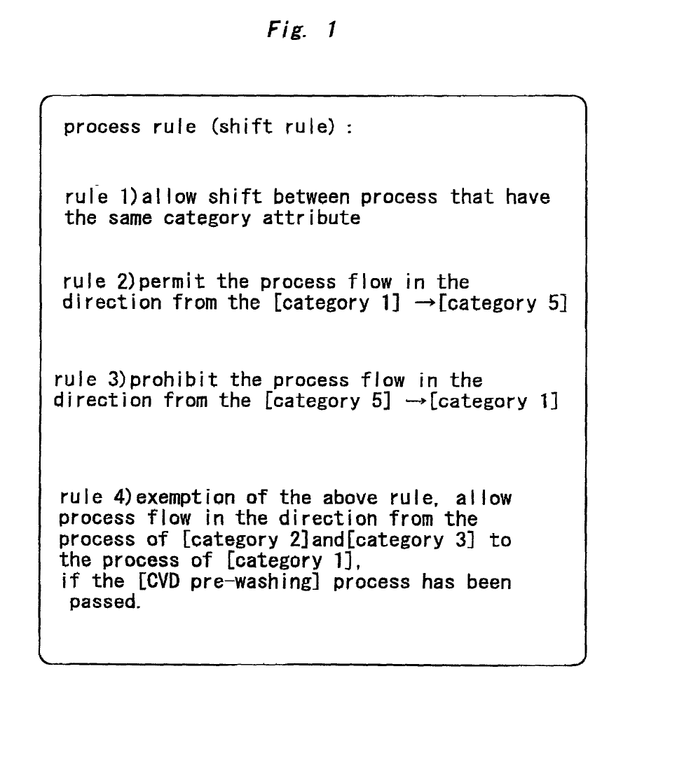

FIG. 1 shows an example of the process rules (shift rule) in Embodiment 1 of the present invention. As FIG. 1 shows, Rule 1 is the rule to allow shift between processes that have the same category attribute. Rule 2 is the rule to permit the flow in the direction from the process of “Category 1” to the process of “Category 5”, that is, the rule to specify the direction of allowable shift between processes. Rule 3 is the rule to prohibit, as a rule, the process flow in the direction from the process of “Category 5” to “Category 1”, that is, the rule to specify the direction of prohibited shift between processes. Rule 4 specifies the exemption of Rule 3, and is the rule to allow process flow in the direction from the process of “Category 2” and “Category 3” to the process of “Category 1”, if the “CVD pre-washing” process has been passed. The above-described shift rules are sequentially tried from Rule 1 to Rule 4 (determination means to determine the recognition of shift). That is, if shift is denied by Rule 1, the application of Rule 2 is tried as the next step. Although only four shift rules are shown in FIG. 1, this is just an example, and the number of shift rules is not limited to four. Also in this example, although the number of categories is five, this is just an example, and the number of categories is not limited to five. The above-described shift rules can be recorded as the file (shift rule section) in a desired recorder.

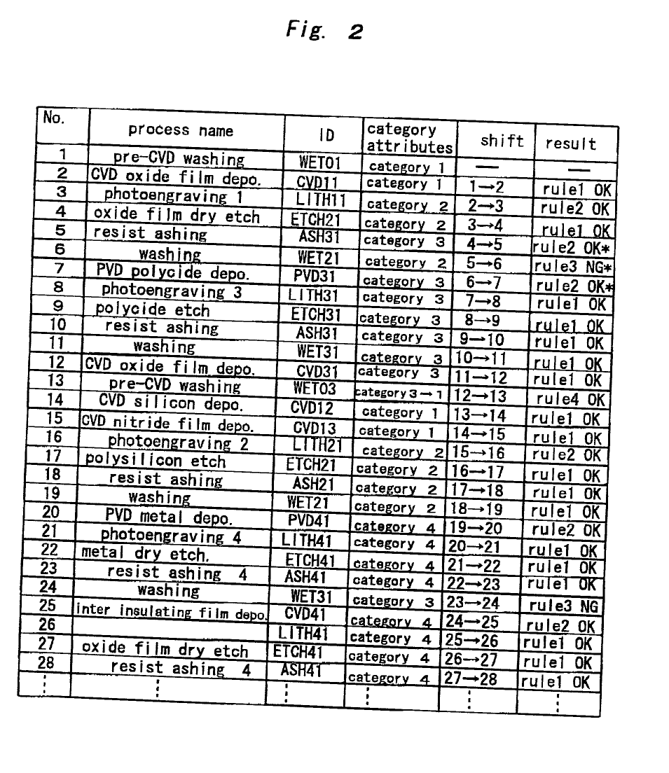

FIG. 2 shows a list of example determinations of the process flow (manufacturing flow recording section) by the shift rule shown in FIG. 1. As FIG. 2 shows, the columns of process numbers, process names, IDs of process equipment, category attributes, the shift of the process to be determined, and the result of determination in which the shift rule is applied to the shift, are shown from the left. For example, the row of Process No. 2 shows that the process name is “CVD oxide film deposition”, the process equipment ID is “CVD 11”, the category attribute is “Category 1”, and the shift of the process to be determined is “from Process 1 to Process 2 (1→2)”. When the shift rule 1 is first applied to this shift (1→2), since the category attribute of Process No. 2 is “Category 1”, and the category attribute of Process No. 1 is “Category 1”, the shift rule 1 is satisfied, and the result of determination is “Rule 1 OK”.

Note the shift of Process Nos. 4→5→6 shown in FIG. 2. Since the result of the application of the shift rule to the sift between simply two processes is described in the column of determination result in FIG. 2, the shift of the row of Process No. 6 (5→6) is determined as “Rule 3 NG” according to Rule 3. That is, since Process No. 6 has the category attribute of “Category 3”, and Process No. 6 has the category attribute of “Category 2”, the shift (5→6) is denied according to Rule 3 that prohibits the process flow from the process of “Category 5” to “Category 1”. However, if determination is carried out here after changing the category attribute of Process No. 6 to “Category 4”, the shift of the row of Process No. 6 (5→6) is accepted as complying with Rule 2, but the shift of the row of Process No. 7 (6→7) is denied as not complying with Rule 3. Thus, when the correction of the category attribute of a process causes a new NG in the next process, the algorithm to correct the shift currently not accepted may not be corrected properly. In such a case, for example, the entire consistency can be obtained by changing the category attribute of Process No. 5, i.e. one before Process No. 6 of which shift (5→6) is prohibited, from “Category 3” to “Category 2”. It is practically useful to prepare the correction algorithm (correction means) so that proper correction does not cause new NG, as well as to determine the simple shift between two processes. When the shift is denied, desired warning can be given to operators or the like by indicating the message on the display of process equipment or the controller for controlling the process equipment, or by generating voice (warning means).

According to Embodiment 1, as described above, the shift between desired processes can be limited and corrected, by establishing shift rules to recognize the shift between processes in the manufacturing flow based on category attributes, and applying these shift rules to the manufacturing flow recording section in which information containing process equipment IDs, shift between processes, category attributes, and the like are recorded. Thus, the contamination of process equipment and products can be avoided.

Embodiment 2

Next, a system and a method for limiting the order of a plurality of specific processes in the manufacturing flow will be described referring to examples.

In Embodiment 2, there is considered the case where process names and process equipment IDs are used as the keys to check the process rules. As shown below, six parameters [1] through [6] are specified for defining one process rule.

Parameter [1] (Starting process: starting process name or process equipment ID) The manufacturing flow is retrieved, and if the starting process name or process equipment ID is found, flow check is started (process identifier).

Parameter [2] (Direction of flow check: normal order or reverse order) This is a parameter to specify the direction of flow check. The “normal order” shows the same direction as the manufacturing flow, and the “reverse order” shows the direction opposite to the manufacturing flow (direction identifier).

Parameter [3] (Prohibited process: process name or process equipment ID containing the wildcard (*)). If the prohibited process or process equipment ID is present between the starting process and the ending process, the process name or process equipment ID to be error is indicated (prohibited process identifier).

Parameter [4] (Essential process: process name or process equipment ID containing the wildcard (*)). If no essential process is present between the starting process and the ending process, the process name or process equipment ID to be error is indicated (essential process identifier).

Parameter [5] (Ending process: ending process name or process equipment ID). If the ending process name or process equipment ID is found during flow check, the flow check is halted. In the case of omitting this parameter, there is the number of testing processes of the following parameter [6] (ending process identifier).

Parameter [6] (Number of testing processes: number of processes). This parameter indicated the number of processes to be retrieved from the starting process. When this parameter is omitted, the processes are retrieved to the last process (the first process in the case of reverse order).

If a plurality of prohibited process names and essential process names are listed, these are treated by “OR”. By using the above-described parameters, the process rule to specify the order of appearance between processes (order rule) can be established for specific process having a plurality of process steps in the manufacturing flow. This order rule can be recorded in a desired recording device as a file (order rule) or the like.

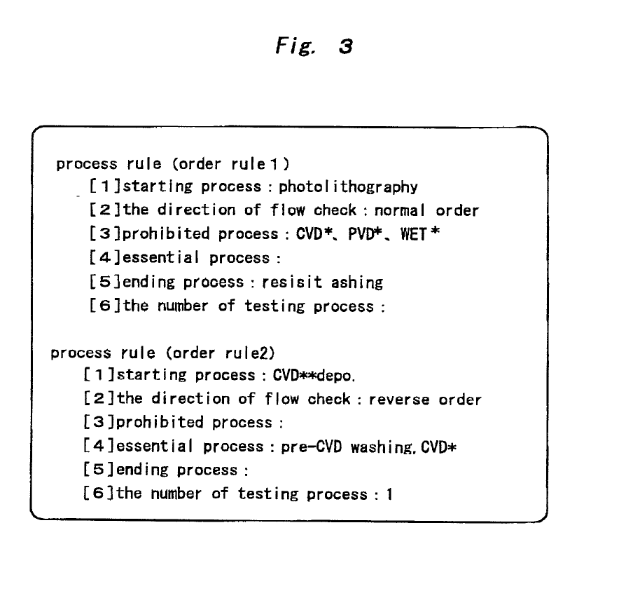

FIG. 3 shows an example of order rules to specify the order of appearance between processes in Embodiment 2 of the invention established using the above-described parameters. As FIG. 3 shows, in the order rule 1, the starting process of parameter [1] is the “photoengraving” process, the direction of flow check of parameter [2] is the “normal order”, the prohibited process (process equipment ID) of parameter [3] is “CVD*, PVD*, WFT*”, the essential process of parameter [4] is omitted, the ending process of parameter [4] is the “resist ashing” process, and the number of testing processes is omitted. This order rule 1 shows that flow check is conducted for specific process having a plurality of process steps (from “photoengraving” to “resist ashing”. The direction of flow check is in the normal order, and check is performed to the last process step as long as the above-described processes are found. Since the prohibited process (process equipment ID) is “CVD*, PVD*, WET*”, the order of relevant processes is denied if any of process equipment IDs of, for example, “CVD 11”, “PVD 31”, or “WET 03” is found.

As described above, the application of the order rule 1 prevents the resist applied in the photoengraving process from remaining unremoved in the “resist ashing” process and the process equipment ID from being carried to CVD*, PVD*, and WET*.

As FIG. 3 shows, in the order rule 2, the starting process of parameter [1] is the “CVD**deposition” process, the direction of flow check of parameter [2] is the “reverse order”, the prohibited process (process equipment ID) of parameter [3] is omitted, the essential process of parameter [4] is “CVD pre-cleaning, CVD*”, the ending process of parameter [5] is omitted, and the number of testing processes is 1. This order rule 2 shows that flow check is conducted for specific process having a plurality of process steps (“CVD**deposition” process for example, from the CVD silicon deposition process to the process of one step before). The direction of flow check is in the reverse order. Since the essential process (process equipment ID) is “CVD pre-cleaning, CVD*”, the order of relevant processes is denied if, for example, “CVD pre-cleaning” or “CVD*” is not found in the process of one step before the CVD) oxide deposition process.

As described above, the application of the order rule 2 prevents wafers other than normal wafers cleaned in the “CVD pre-cleaning” process from being carried to “CVD**deposition”, thus maintaining the cleanliness of the CVD process.

The above-described order rules 1 and 2 are independently applied to each process step in the manufacturing flow (determination means for determining the recognition of order, and the recognition of existence). Although only two order rules are shown in FIG. 3, this is only to show an example, and there is no limitation in the number of order rules.

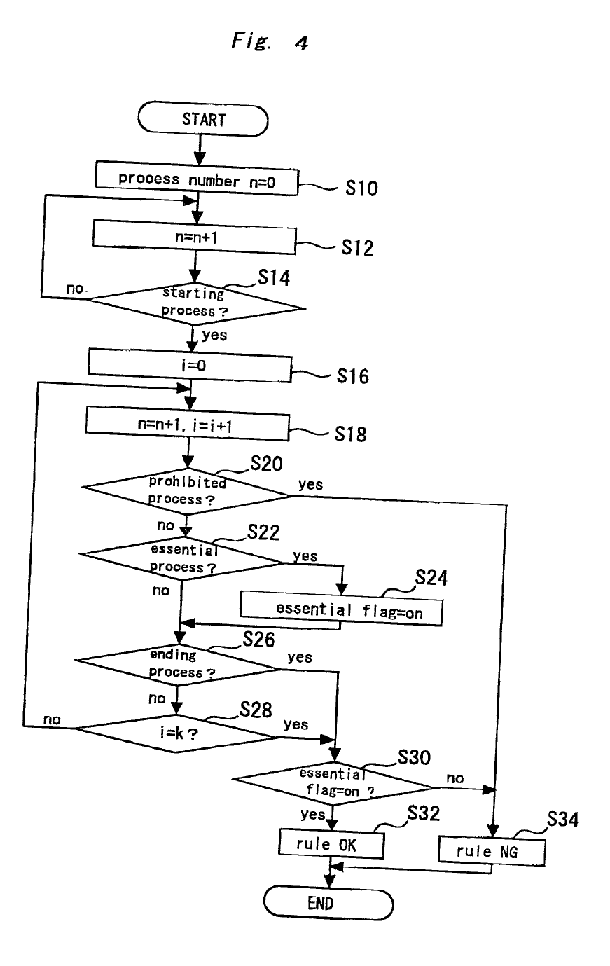

FIG. 4 shows a method for checking the manufacturing flow using the order rules in Embodiment 2 of the present invention using a flow chart. The flow chart shown in FIG. 4 shows the example of the case to retrieve whether or not “prohibited process”, “essential process”, and “ending process” are found within k processes form “starting process” in normal order in the manufacturing flow.

As FIG. 4 shows, 0 is first set to the variable n that indicates the process number (Step S10). To the variable n, 1 is added (Step S12), to determine whether or not the process indicated by the variable n is the starting process shown in the order rules (Step S14). If the process is not the starting process nor ending process (STEP S16), the process is repeated from Step S12. If the process is the starting process, but is not the ending process, the variable i to count the number of processes is set to 0 (Step S20).

Next, 1 is added to the variable i (Step S22), to determine whether or not the process indicated by the variable n+i falls under the prohibited process shown in the order rules (Step S26). If the process falls under the prohibited process, a flag to indicate that the order between relevant processes has been denied by the order rules (NG) is set ON (Step S28), and the check is proceeded to Step S36. If the process does not fall under the prohibited process, whether or not the process indicated by the variable n+i falls under the essential process shown in the order rules is determined (Step S30). If the process falls under the essential process, the essential flag is set ON (Step S 32), and the check is proceeded to Step S 34. If the process does not fall under the essential process, the check is proceeded to Step S 34. In Step S 34, whether or not the process indicated by the variable n+i falls under the ending process is determined. If the process does not fall under the ending process, whether or not the n+i process falls under the final process is checked, and if it does not fall under the final process, whether or not the variable i to count the number of processes equals to the number of tests (k) is determined (Step S38), and if it does not equal to, check is repeated from Step S22. If the variable i is determined to equal to the number of tests (k), or if the process is determined to fall under the ending process in Step S 34, the process is repeated from Step S 12. When the test is proceeded to the final process, whether or not the prohibition flag has been set ON is checked (Step S40). If the relevant flag is not ON, whether or not the essential flag is set ON is checked (Step S42). If the essential flag has been set ON, the order rules approved the order between relevant processes (OK), and check is ended (Step S44). If the prohibition flag is set ON and the essential flag is not set ON, the order rules denied the order between relevant processes (NG), and check is ended (Step S46).

By establishing a plurality of order rules consisting of six parameters, as described above, the manufacturing flow can be checked. Although the flow chart shown in FIG. 4 shows the case where the direction of flow check is in the normal order, if the direction of flow check is in the reverse order, the addition of the variable n in Step S12 and Step S24 is changed to detraction.

If the number of tests (k) is omitted in the order rules, check can be repeated to the last process of the manufacturing flow.

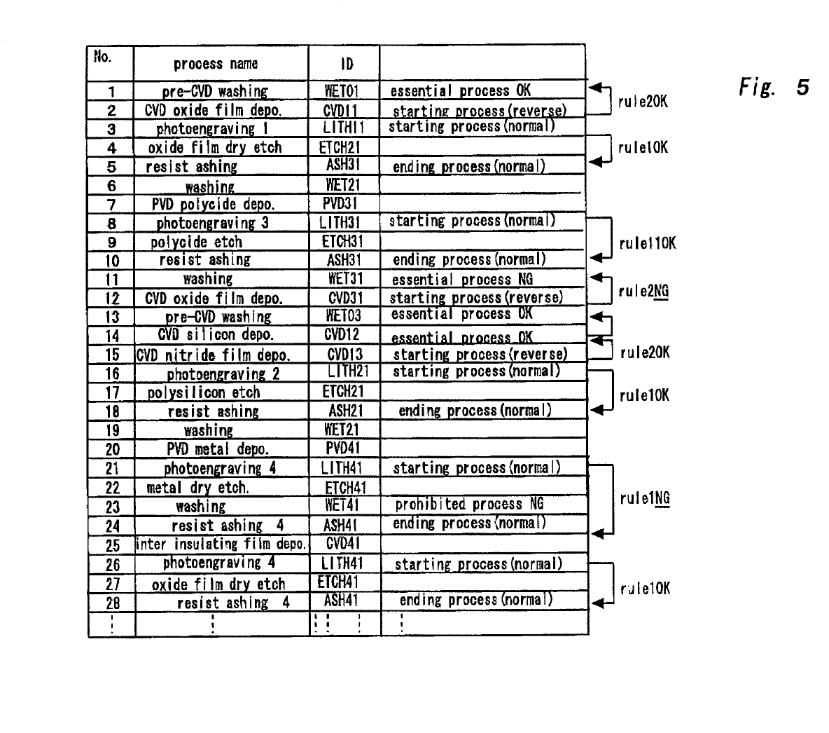

FIG. 5 shows a list of example determinations of the process flow (manufacturing flow recording section) by the order rules shown in FIG. 3 and the flow chart shown in FIG. 4. As FIG. 5 shows, the columns of process numbers, process names (process identifiers), IDs of process equipment, and the result of determination in which the shift rule is applied to the shift, are shown from the left. For example, the row of Process No. 2 shows that the process name is “CVD oxide film deposition” and the ID of process equipment is “CVD 11”.

As FIG. 5 shows, it is known for example, that since Process No. 3 is one photoengraving process, this falls under the starting process of the order rule 1 (photoengraving process). Next, since the process equipment ID of Process No. 4 is ETCH 21, it is known that this does not fall under any of the prohibited process of the order rule 1 (process equipment ID) and (CVD*, PVD*, WET*). Next, since Process No. 5 is the resist ashing process, it is known that this falls under the ending process (resist ashing process) of the order rule 1, and the determination such as “Order rule 1 OK” can be entered in the determination result column. According to the test algorithm, the following Process Nos. 8 through 10, 16 through 18, 21 through 24, and the like can also be checked. In the check of Process Nos. 21 through 24, since WET 41 of the prohibited process (process equipment ID) has been found in Process No. 23, the determination result of “prohibited process NG” is entered in the determination result column.

As described above, the flow chart shown in FIG. 4 can be applied to the case where the direction of flow check is in the reverse order if it is partially corrected. As FIG. 3 shows, the result shown in FIG. 5 can be obtained by the use of the order rule 2 in which the direction of flow check is in the reverse order. For example, since Process No. 2 is the CVD oxide film deposition process, it is known that this falls under the starting process (CVD**deposition) of the order rule 2. Since the process name of the process one before Process No. 1 is CVD pre-cleaning, it is known that this is the essential process (CVD pre-cleaning). Since the number of tests of the order rule 2 is 1, the determination such as the order rule 2 OK (essential process OK) can be entered in the determination result column. The other process to which the order rule 2 is applied is Process No. 12 or 11. Since the essential process is not present in this process, the determination such as the order rule 2 NG (essential process NG) is entered in the determination result column.

Also in Embodiment 2, as in Embodiment 1, it is practically useful to prepare the correction algorithm (correction means) so that proper correction does not cause new NG, as well as to determine the simple shift between two processes. When the shift is denied, desired warning can be given to operators or the like by indicating the message on the display of process equipment or the controller (not shown) for controlling the process equipment, or by generating voice (warning means).

According to Embodiment 2, as described above, the order between desired processes can be limited and corrected, by establishing order rules to recognize the order between processes or to recognize the presence in the manufacturing flow using a plurality of parameters that determine the starting process or the like, and applying these order rules to the manufacturing flow recording section in which information containing process names, process equipment IDs, and the like are recorded. Thus, the contamination of process equipment and products can be avoided.

Embodiment 3

Next, a method for limiting parameters of the processes to a predetermined range will be described referring to examples, for the combinations of a plurality of specific processes (or process equipment) in the manufacturing flow.

In Embodiment 3, the process names and process equipment IDs are used as keys to check process rules. As shown below, the following six parameters [1] through [6] are specified to define one process rule.

Parameter [1] (Starting process: starting process name that contains a wildcard (*) or process equipment ID). The manufacturing flow is retrieved, and if the starting process name or process equipment ID is found, flow check is started (process identifier).

Parameter [2] (Direction of flow check: normal order or reverse order). This is a parameter to specify the direction of flow check. The “normal order” shows the same direction as the manufacturing flow, and the “reverse order” shows the direction opposite to the manufacturing flow (direction identifier).

Parameter [3] (Limited process: process name or process ID containing the wildcard (*) or process equipment ID). The process name or the process equipment ID is indicated between the starting process and the ending process (conditional process identifier).

Parameter [4] (Limiting condition) The range of parameter values of the limited process is indicated (condition section).

Parameter [5] (Ending process: ending process name or process equipment ID). If the ending process name or process equipment ID is found during flow check, the flow check is halted. In the case of omitting this parameter, there is the number of testing processes of the following parameter [6] (ending process identifier).

Parameter [6] (Number of testing processes: number of processes). This parameter indicates the number of processes to be retrieved from the starting process. When this parameter is ornitted, the processes are retrieved to the last process (the first process in the case of reverse order).

When a plurality of limited process names are listed, “AND” is used for processing. By using the above-described parameters, a process rule to specify the relationship between parameter values recorded in the parameter section in the relevant process (parameter value rule) can be established for a specific process that has a plurality of process steps in the manufacturing flow. This parameter value rule can be recorded in a desired recorder as a file (parameter value rule section) or the like.

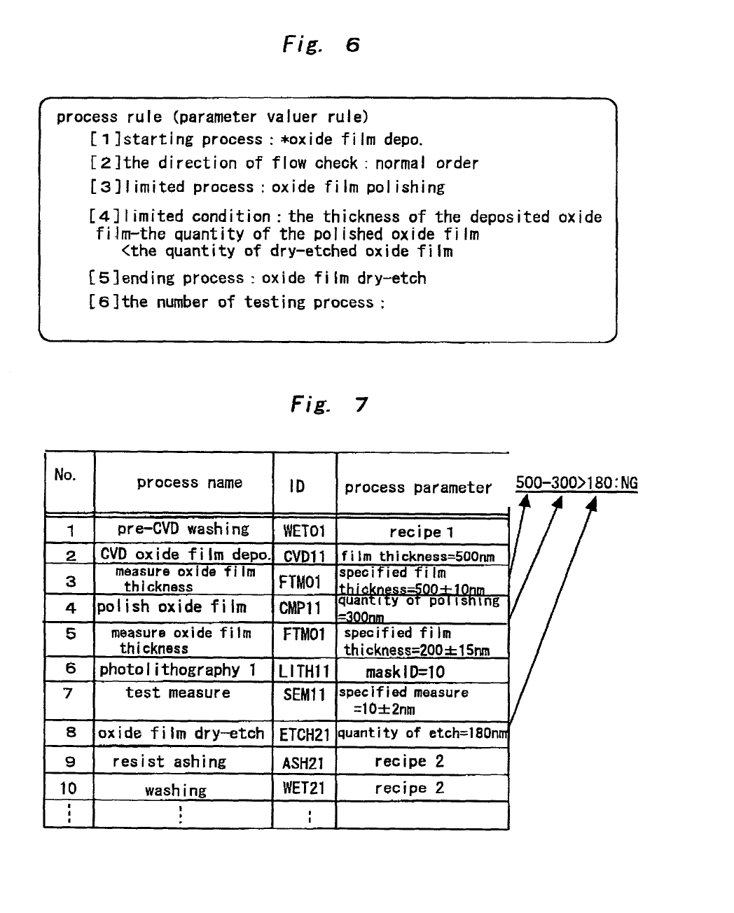

FIG. 6 shows an example of order rules to specify the order of appearance between processes established using the above-described parameters in Embodiment 3 of the invention. As FIG. 6 shows, the starting process of parameter [1] is the “*oxide film deposition” process: the direction of flow check of parameter [2] is the “normal order”; the limited process of parameter [3] is “oxide film polishing”; the limiting condition of parameter [4] is “(the thickness of the deposited oxide film—the quantity of the polished oxide film)<the quantity of dry-etched oxide film”; the ending process of parameter [5] is the “oxide film dry etching” process, and the number of tests of parameter [6] is omitted. This parameter value rule shows that the flow check is performed for a specific process having a plurality of process steps in the manufacturing flow (from the “oxide film deposition” to the “oxide film dry etching” process). The flow check is performed in the normal order to the last process, as long as the above-described specific process is found. The thickness of the deposited oxide film, the quantity of the polished oxide film, and the amount of the dry-etched oxide film in “(the thickness of the deposited oxide film−the quantity of the polished oxide film)<the quantity of dry-etched oxide film” can be obtained from process parameters (described below) in each process between the “*oxide film deposition” process of the starting process and the “oxide film dry etching” process of the ending process. Since the limiting process is the “oxide film deposition” process, the quantity of the polished oxide film subjected to the determination can be obtained form the process parameters in this process. The limiting condition is determined in the “oxide film dry etching” process of the ending process, and whether the limiting condition is established or not is determined (determination means for determining the establishment of the relationship between parameter values).

As described above, it can be checked by applying the parameter value rule, that the hole opened by the dry etching of the oxide film has reached the surface before the CVD oxide film deposition process. Although only one parameter value rule is shown in FIG. 6, this is only an example, and there is no limitation in the number of parameter value rules.

Since the method for checking the manufacturing flow using parameter value rules is the same as the flow chart in FIG. 4 described with respect to Embodiment 2, the description of the method is omitted.

FIG. 7 shows a list of example determinations of the process flow (manufacturing flow recording section) by the parameter value rule shown in FIG. 6 and the flow chart shown in FIG. 4. As FIG. 7 shows, the columns of process numbers, process names (process identifiers), IDs of process equipment, and the process parameters, are shown from the left. For example, the row of Process No. 2 shows that the process name is “CVD oxide film deposition”, the ID of process equipment is “CVD 11”, and the process parameter is “film thickness=500 nm”.

As FIG. 7 shows, since Process No. 2 is the CVD oxide film deposition process, it is known that this falls under the starting process of the parameter value rule (“*oxide film depositions” process). The film thickness=500 nm can be obtained from the column of the process parameter of the relevant process. Since Process No. 4 is the oxide film polishing process, it is known that this falls under the limited process of the parameter value rule (oxide film polishing process). The polished quantity=300 nm can be obtained from the column of the process parameter of the relevant process. Since Process No. 8 is the oxide film dry etching process, it is known that this falls under the ending process of the parameter rule (oxide film dry etching process). The etched quantity=180 nm can be obtained from the column of the process parameter of the relevant process. When the limiting condition is determined here, since the deposited oxide film thickness (500 nm)−the quantity of the polished oxide film (300 nm)=200 nm<the quantity of dry-etched oxide film (180 nm) is not established, the determination of non-establishment (NG) is given. That is, in this example, since the oxide film of 500 nm formed in Process No. 2 is polished by 300 nm in Process No. 4, and the remaining oxide film of 200 nm is dry-etched by the depth of 180 nm, it is determined that the limiting condition is not satisfied.

Also in Embodiment 3, as in Embodiments 1 and 2, it is practically useful to prepare the correction algorithm (correction means) so that proper correction does not cause new NG, as well as determination. When the limiting condition is not established, warning can be given to operators or the like by indicating the message on the display of process equipment or the controller (not shown) for controlling the process equipment, or by generating voice (warning means).

As the application of the above-described parameter value rule, various variations for correcting the parameters of processes that will be performed, utilizing the monitor values in the processes that have been completed, will be described below.

Variation 1

In FIG. 7, at the stage that the processes have been completed to Process No. 3, the measured film thickness value (500 nm) is compared with the specified film thickness (500±10 nm), and if it is not within the specification, alarm is generated.

Variation 2

In FIG. 7, at the stage that the processes have been completed to Process No. 5, the film thickness measured in Process No. 5 is compared with the quantity of dry-etched film of Process No. 7 (189 nm), instead of [the thickness of the deposited oxide film−the quantity of the polished oxide film], and if it is not within the specification, alarm is generated.

Variation 3

In FIG. 7, at the stage that the processes have been completed to Process No. 3, the measured film thickness (500 nm) is compared with the specified film thickness (500±10 nm), and if it is not within the specification, the quantity of the polished oxide film (300 nm) of Process No. 4 is corrected by offset quantity to satisfy the specification (200±15 nm) of Process No. 5.

Variation 4

In FIG. 7, at the stage that the processes have been completed to Process No. 5, the measured film thickness value (500 nm) is compared with the specified film thickness (500±10 nm), and if it is larger than the specification, the oxide film polishing process is added between Process Nos. 5 and 6 for additional polishing by the quantity exceeding the specification.

According to Embodiment 3, as described above, the establishment of relationship between desired process parameters can be determined and corrected, by specifying the parameter value rule fur determining the establishment of relationship between desired process parameters in the manufacturing flow, and by applying this parameter value rule to the manufacturing flow recording section that records information containing process names, process equipment IDs, and the like. Thereby the occurrence of defective products can be avoided.

Embodiment 4

If process equipment, such as a wafer treatment apparatus, is contaminated by the wafer brought in the process equipment, what contributes to contamination is the material exposed on the uppermost surface of the wafer. Therefore, if the material substance present on the uppermost surface of the wafer can be identified in a certain process in the manufacturing flow, the possibility of the contamination of process equipment used in this process can be determined. The material exposed present on the uppermost surface of the wafer can be estimated based on the manufacturing flow. However, only the above-described parameters contained in the manufacturing flow are generally insufficient, and the pattern data of the mask used in the photoengraving process of the semiconductor device, the process characteristic data of the process equipment used in manufacturing, and the like are additionally required. If the physical phenomena that occur on the wafer in process equipment are simulated based on these data, the three-dimensional topography on the surface of the wafer in the specific process can be estimated, and as a result, the material exposed on the uppermost surface can be identified. Embodiment 4 uses an existing topographic simulator as the topographic simulator for above-described simulation, and uses the result of the simulation for testing the adequacy of the manufacturing flow.

FIG. 8 shows the flow of data in checking the process rule in Embodiment 4. As FIG. 8 shows, the rule check is performed in the rule check section 31 for applying the specified process rule 30 the manufacturing flow data 34, such as parameters contained in the manufacturing flow. This is the same as the methods used in the above-described embodiments. When there is a simulation rule to activate the existing topography simulator 32 in the process rule 30, the request to activate the topography simulator 32 is transmitted (Step S50). Next, the manufacturing flow data 34, the process characteristic data 36 of process equipment used for manufacturing, and the pattern data 38 of the mask used in the photoengraving process of the semiconductor device are given to the topography simulator 32 (Step S52) for topography simulation. The topography simulator 32 returns the material mapping data, the result of simulation to the rule check section 31 (Step S 54). The rule check section 31 tests the adequacy of the manufacturing flow based on the material mapping data, and issues the determination result 40 (Step S56).

In Embodiment 4, process names and process equipment IDs are used as the keys for checking process rules. As shown below, the following three parameters [1] through [3] are specified for defining one process rule.

Parameter [1] (Testing process: process name or process parameter). This retrieves the manufacturing flow, and when this process name, process equipment ID, and process parameter are found, it activates the topography simulator 32.

Parameter [2] (Essential process: material name, thickness). This indicates the name of the material considered to be exposed on the uppermost surface in the testing process (essential material identifier), and the thickness from the uppermost surface.

Parameter [3] (Prohibited material: material name). This indicates the name of the material estimated to damage process equipment or device if it is exposed on the uppermost surface in the testing process (prohibited material identifier).

By using the above-described parameters, the process rule to make the simulator 32 specify the material present on the surface of the wafer in the specific process, for the process before the specific process in the manufacturing flow, by using the parameters recorded in the parameter section in the previous process (simulation rule). This simulation rule can be recorded in a desired recorder as a file (simulation rule section) or the like

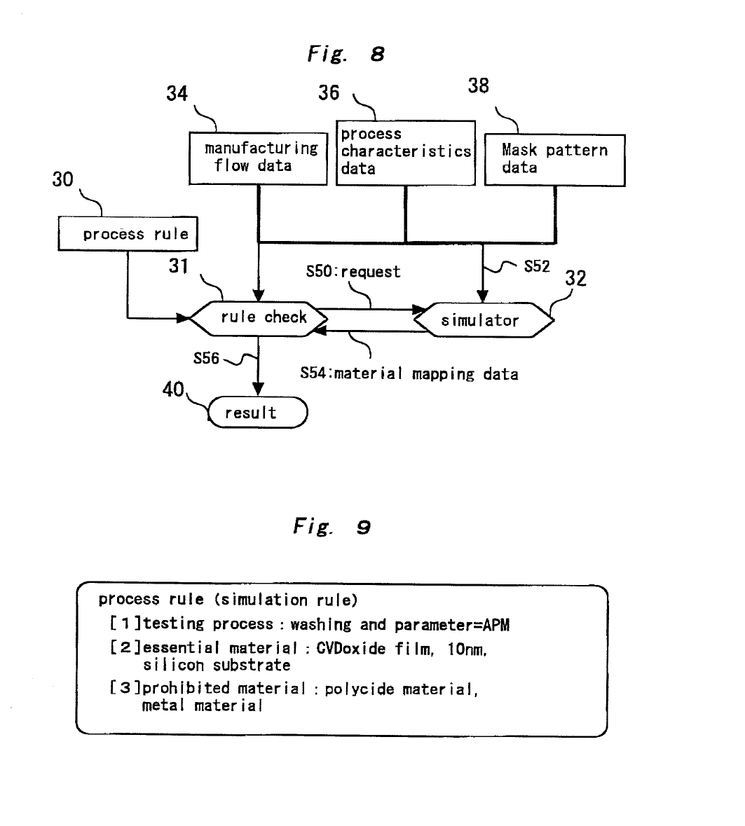

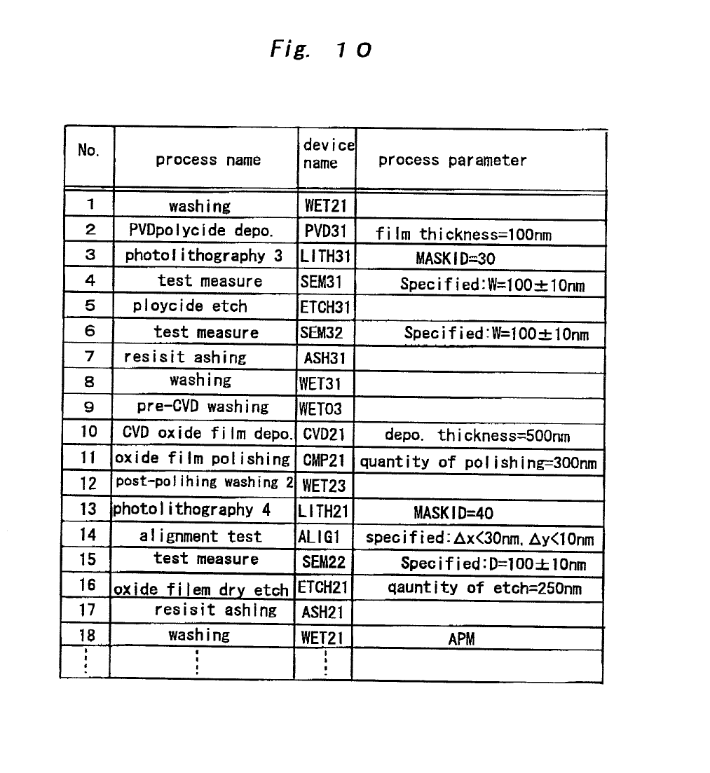

FIG. 9 shows an example of the simulation rule to make the topography simulator specify the material present on the surface of the wafer in Embodiment 4 made by using the above-described parameters. As FIG. 9 shows, the testing process of the parameter [1] is the “cleaning” process, and the parameter is “parameter=APM chemical solution”. The essential material of the parameter [2] is the “CDV oxide film” considered to expose on the uppermost surface on the “silicon substrate”, and the thickness from the uppermost surface is “10 nm”. The prohibited material of the parameter [3] is the “polycide material” and the “metal material”.

By applying the above-described simulation rule, whether or not the polycide film is exposed on the surface of the wafer in the cleaning process using the APM chemical solution can be checked. In FIG. 9, although only one simulation rule is shown, this is only an example, and there is no limitation in the number of simulation rules.

Since the method for checking the manufacturing flow using the simulation rule is the same as the method indicated by the flow chart in FIG. 4 described in Embodiment 2, the description of the method is omitted

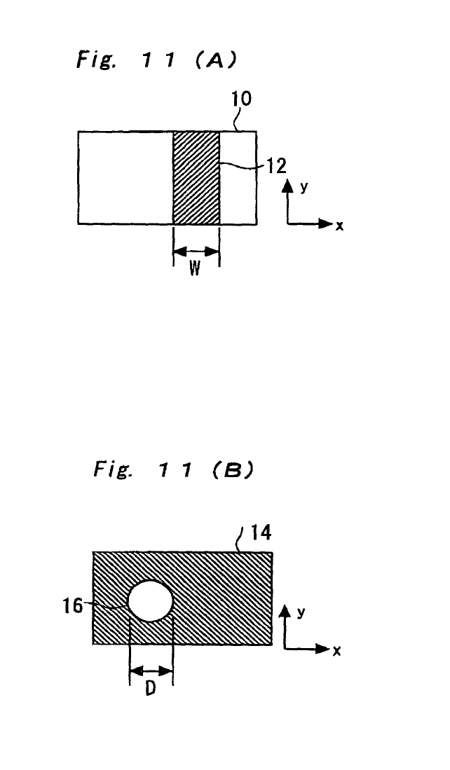

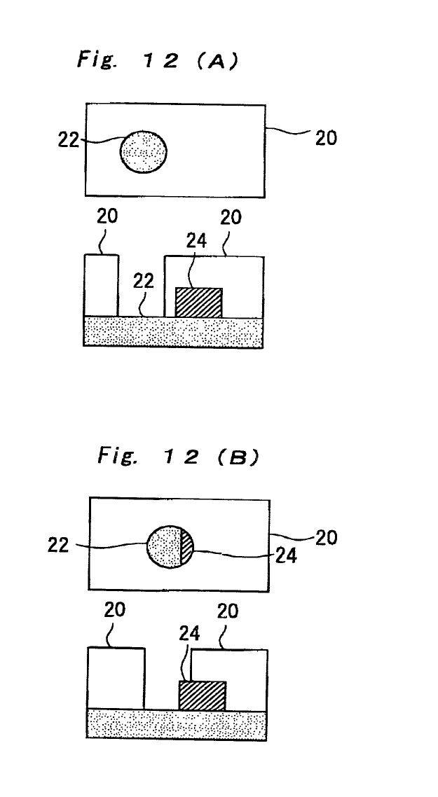

FIG. 10 shows a list of example determinations of the process flow (manufacturing flow recording section) by the simulation rule shown in FIG. 9 and the flow chart shown in FIG. 4. As FIG. 10 shows, the columns of process numbers, process names (process identifiers), IDs of process equipment, and the process parameters, are shown from the left. For example, the row of Process No. 2 shows that the process name is “PVD polycide deposition”, the ID of process equipment is “PVD 31”, and the process parameter is “film thickness=100 nm”.

When the simulation rule shown in FIG. 9 is applied to the example of the manufacturing flow shown in FIG. 10, the parameter APM is passed to the topography simulator 32 in the cleaning process of Process No. 18, and topography simulation is performed. If topography simulation identifies the material present on the surface of the wafer, whether the material matches the above-described prohibited material, the “polycide material” or the “metal material” is determined (determination means to determine matching with the prohibited material).

Also in Embodiment 4, as in Embodiments 1, 2 and 3, it is practically useful to prepare the correction algorithm (correction means) so that proper correction does not cause new NG, as well as determination. When the material identified by the topography simulator 32 matches the prohibited material, warning can be given to operators or the like by indicating the because the possibility where the CVD oxide film 20 is dissolved and the polycide film 24 appears from the bottom is considered.

In actual product manufacturing, realistic product control can be achieved by not only estimating the topography using manufacturing parameters as described above, but also using measured values in completed processes in parallel with manufacturing.

According to Embodiment 4, as described above, it becomes possible to make the topography simulator identify the material on the surface of a wafer, by preparing the above-described simulation rule in the manufacturing flow, and by applying this simulation rule to the manufacturing flow recording section in which information containing process names, process equipment IDs, and the like. By using the result of simulation in testing the adequacy of the manufacturing flow, the occurrence of defective products or the contamination of process equipment can be avoided.

Embodiment 5

In the above-described Embodiment 4, process performance data are used for topography simulation. However, since the performance data of actual process equipment frequently change by aging, there may be the case where simulation cannot be performed properly when there is change in the state of equipment by aging (aging properties). In order to avoid the effect of change in the state of equipment, the operation to initialize process equipment by temporarily interrupting manufacturing is required. However, if change in process performance can be monitored in real time, or can be estimated empirically, change in the state of equipment can be compensated by changing the parameters of the manufacturing flow. In order to realize this, the process performance data and the database that has the variation function thereof are added to the above-described manufacturing flow control system. By this, for example, since even etching equipment of which etching rate lowers corresponding to the accumulated process time after equipment initialization can automatically correct the etching time parameter in the manufacturing flow corresponding to the etching rate, a desired etching quantity can be realized. By the use of the above-described functions, more accurate parameter correction can be performed even in the case as Embodiment 3.

According to Embodiment 5, as described above, by adding the process performance data and the database that has the variation function thereof to the manufacturing flow control system shown in the above-described embodiments, change in the state of equipment can be compensated by changing the parameters of the manufacturing flow, even in process equipment of which state changes by aging.

Although the case where the manufacturing flow is tested or corrected using different methods is described above for each embodiment of the invention, it is needless to say that a plurality of these methods can be used in combination.

According to the present invention, as described above, there are provided the system and method for controlling the manufacturing flow of semiconductor devices that can prevent the occurrence of defective semiconductor devices or the damage of manufacturing equipment caused by lack of knowledge or carelessness of the designer of the semiconductor device manufacturing flow, by preparing various rules such as the shift rule to recognize the shift between processes in the manufacturing flow based on the category attribute, and by applying these rules to the manufacturing flow recording section in which information containing process names, process equipment IDs, and the like.

In the system for controlling the flow of manufacturing semiconductor devices, the shift rule may be applied to the category attribute for each process recorded in the manufacturing flow recording section, and may further comprise a determination means for determining the recognition of shift between each process.

Here, the system for controlling the flow of manufacturing semiconductor devices may further comprise a correction means for correcting the manufacturing flow by changing the category attribute for the relevant process, when there is a process for which the determination means has denied the shift thereof.

Here, the system for controlling the flow of manufacturing semiconductor devices may further comprise a warning means for warning when there is a process for which the determination means has denied the shift thereof.

In the system for controlling the flow of manufacturing semiconductor devices, the order rule recorded in the order rule recording section may have, the step identifier, a direction identifier for indicating the test direction in the manufacturing flow of the specific processes, a prohibited step identifier for indicating the step whose presence is prohibited in the specific processes, an essential step identifier for indicating the step whose presence is essential in the specific processes, a process completion identifier for indicating the completion of the specific processes, and a test number identifier for indicating the number of steps that require testing.

In the system for controlling the flow of manufacturing semiconductor devices, the order rule may be applied to the step identifier recorded in the manufacturing flow recording section, and further comprising a determination means for determining the recognition of the order of each step and the recognition of the presence of each step.

Here, the system for controlling the flow of manufacturing semiconductor devices may further comprise a correction means for correcting the manufacturing flow by changing the order or presence of the relevant process, when there is a process for which the determination means has denied the order or presence thereof.

Here, the system for controlling the flow of manufacturing semiconductor devices may further comprise a warning means for warning when there is a process for which the determination means has denied the order or presence thereof.

In the system for controlling the flow of manufacturing semiconductor devices, the parameter value rule recorded in the parameter value rule recording section may have, a step identifier of the specific step, a direction identifier for indicating the test direction in the manufacturing flow of the specific processes, a condition section for indicating the relationship between parameter values, a conditional process identifier subjected to the determination of the relationship indicated by the condition section, a process completion identifier for indicating the completion of the specific processes, and a test number identifier for indicating the number of steps that require testing.

In the system for controlling the flow of manufacturing semiconductor devices, the parameter value rule may be applied to the parameter section recorded in the manufacturing flow recording section, and further comprising a determination means for determining the existence of the relationship between parameter values indicated by the condition section.

Here, the system for controlling the flow of manufacturing semiconductor devices may further comprise a correction means for correcting the manufacturing flow by changing the parameter value recorded in the parameter section for the process, when there is a process for which the determination means has denied the existence thereof.

Here, the system for controlling the flow of manufacturing semiconductor devices may further comprise a warning means for warning when there is a process for which the determination means has denied the existence thereof.

In the system for controlling the flow of manufacturing semiconductor devices, the simulation rule recorded in the simulation rule recording section may have, a step identifier of the specific step, a parameter used when the shape simulator is activated, an essential material identifier indicating the material whose existence on the surface of the wafer is assumed in the specific step, and a prohibited material identifier for indicating the prohibited material considered to damage the semiconductor device, when present on the surface of a wafer in the specific step.

Here, the system for controlling the flow of manufacturing semiconductor devices may further comprise a determination means for determining the coincidence of the material present on the surface of a wafer identified by the shape simulator using the simulation rule, with the prohibited material indicated by the prohibited material identifier.

Here, the system for controlling the flow of manufacturing semiconductor devices may further comprise a correction means for correcting the manufacturing flow by changing the parameter value recorded in the parameter section of the step before the specific step, when the determination means has determined coincidence.

Here, the system for controlling the flow of manufacturing semiconductor devices may further comprise a warning means for warning when the determination means has denied coincidence.

Here, the system for controlling the flow of manufacturing semiconductor devices may further comprise a parameter correction means for correcting the parameter contained in the parameter section of the step recorded in the manufacturing flow recording section to the parameter reflecting the time characteristics of the device used in the step.

Here, the method for controlling the flow of manufacturing semiconductor devices may further comprise a parameter correction step for correcting the parameter contained in the parameter section of the step recorded in the manufacturing flow recording section to the parameter reflecting the time characteristics of the device used in the step.

The present invention has been described in detail with respect to various embodiments, and it will now be apparent from the foregoing to those skilled in the art that changes and modifications may be made without departing from the invention in its broader aspects, and it is the invention, therefore, in the appended claims to cover all such changes and modifications as fall within the true spirit of the invention.

The entire disclosure of Japanese patent application no 2000-339632 filed on Nov. 7, 2000 including specification, claims, drawings and summary are incorporated herein by reference in its entirety.

What is claimed is:

1. A system for controlling the flow of manufacturing semiconductor devices comprising:
a manufacturing flow recording section for recording information for each process of said manufacturing flow, containing the category attribute that indicates the classification according to materials used in said process; and
a shift rule section for recording the shift rule by which the recognition of shift between each process of said manufacturing flow is decided based on said category attribute.

2. The system for controlling the flow of manufacturing semiconductor devices according to claim 1, wherein said shift rule is applied to the category attribute for each process recorded in said manufacturing flow recording section, and further comprising a determination means for determining the recognition of shift between each process.

3. The system for controlling the flow of manufacturing semiconductor devices according to claim 2, further comprising a correction means for correcting the manufacturing flow by changing the category attribute for the relevant process, when there is a process for which said determination means has denied the shift thereof.

4. The system for controlling the flow of manufacturing semiconductor devices according to claim 3, further comprising a warning means for warning when there is a process for which said determination means has denied the shift thereof.

5. The system for controlling the flow of manufacturing semiconductor devices according to claim 2, further comprising a warning means for warning when there is a process for which said determination means has denied the shift thereof.

6. A system for controlling the flow of manufacturing semiconductor devices comprising:
a manufacturing flow recording section for recording information for each process of said manufacturing flow, containing the process identifier that describes the relevant process; and
an order rule section for recording the order rule that specifies the order of appearance of each step for specific processes that contains a plurality of steps in said manufacturing flow recording section.

7. The system for controlling the flow of manufacturing semiconductor devices according to claim 6, wherein said order rule recorded in said order rule recording section has,
said step identifier, a direction identifier for indicating the test direction in the manufacturing flow of said specific processes, a prohibited step identifier for indicating the step whose presence is prohibited in said specific processes, an essential step identifier for indicating the step whose presence is essential in said specific processes, a process completion identifier for indicating the completion of said specific processes, and a test number identifier for indicating the number of steps that require testing.

8. The system for controlling the flow of manufacturing semiconductor devices according to claim 7, wherein said order rule is applied to said step identifier recorded in said manufacturing flow recording section, and further comprising a determination means for determining the recognition of the order of each step and the recognition of the presence of each step.

9. The system for controlling the flow of manufacturing semiconductor devices according to claim 8, further comprising a correction means for correcting the manufacturing flow by changing the order or presence of the relevant process, when there is a process for which said determination means has denied the order or presence thereof.

10. The system for controlling the flow of manufacturing semiconductor devices according to claim 9, further comprising a warning means for warning when there is a process for which said determination means has denied the order or presence thereof.

11. The system for controlling the flow of manufacturing semiconductor devices according to claim 8, further comprising a warning means for warning when there is a process for which said determination means has denied the order or presence thereof.

12. A method for controlling the flow of manufacturing semiconductor devices using, for each process of the manufacturing flow, a manufacturing flow recording section for recording information for each process of said manufacturing flow, containing the category attribute that indicates the classification according to materials used in said process, and a shift rule section for recording the shift rule by which the recognition of shift between each process of said manufacturing flow is decided based on said category attribute, said method comprising the steps of:
a determination step for determining the recognition of shift between each process by applying said shift rule to the category attribute for each process recorded in said manufacturing flow recording section; and
correcting the manufacturing flow by warning or by changing the category attribute for said process, when there is a process for which said determination step has denied the shift.

13. A method for controlling the flow of manufacturing semiconductor devices using, for each process of the manufacturing flow, a manufacturing flow recording section for recording information containing the process identifier that describe the process, and an order rule section for recording the order rule that specifies the order of appearance of each step, wherein the order rule recorded in said order rule recording section has, the step identifier, a direction identifier for indicating the test direction in the manufacturing flow of the specific processes, a prohibited step identifier for indicating the step whose presence is prohibited in the specific processes, an essential step identifier for indicating the step whose presence is essential in the specific processes, a process completion identifier for indicating the completion of the specific processes, and a test number identifier for indicating the number of steps that require testing, said method comprising the steps of:
a determination step for determining the recognition of the order of each step and the recognition of the presence of each step by applying the order rule to the step identifier recorded in the manufacturing flow recording section; and
correcting the manufacturing flow by warning or changing the process when there is a process for which said determination step has denied the order or presence thereof.
